(19) United States
(12) Patent Application Publication
(10) Pub. No.: US 2025/0367588 A1
(43) Pub. Date: Dec. 4, 2025

(54) TEMPERATURE CONTROL SYSTEM FOR CONTROLLING THE TEMPERATURE OF A SORBENT PACKING FOR A DIRECT AIR CAPTURE DEVICE, SORBENT CONTAINER SYSTEM COMPRISING THE TEMPERATURE CONTROL SYSTEM AND DIRECT AIR CAPTURE DEVICE

(71) Applicant: Volkswagen Aktiengesellschaft, Wolfsburg (DE)

(72) Inventors: Frank Beger, Hannover (DE); Marcel Wiegel, Gardelegen (DE); Christian Heimermann, Wolfsburg (DE); Martin Hofer, Braunschweig (DE)

(21) Appl. No.: 19/216,499

(22) Filed: May 22, 2025

(30) Foreign Application Priority Data
May 29, 2024 (DE) 102024115024.6

(51) Int. Cl. B01D 53/04

(52) U.S. Cl. CPC B01D 53/0438; B01D 53/0454; B01D 2253/108; B01D 2253/204; B01D 2257/504; B01D 2258/06

(57) ABSTRACT

A temperature control system regulates the temperature of a sorbent packing for extracting carbon dioxide from a gaseous medium. The system includes a tube system with a tube and a lamella system within the sorbent packing, featuring an elongated lamella. The tube extends along and contacts the longitudinal direction of the lamella. A sorbent container system incorporates this temperature control system, and a device for extracting carbon dioxide from the gaseous medium includes the temperature control system and/or the sorbent container system.

### RELATED APPLICATIONS

The present application claims priority to German Patent App. No. DE102024115024.6, filed May 29, 2024, the contents of which are incorporated by reference in its entirety herein.

### TECHNICAL FIELD

The present disclosure relates to a temperature control system configured to regulate the temperature of a sorbent packing for extracting carbon dioxide from a gaseous medium. The present disclosure further relates to a sorbent container system including the temperature control system, a device for extracting carbon dioxide from a gaseous medium, and the use of the temperature control system to regulate the temperature of the sorbent packing.

### BACKGROUND

The emission of carbon dioxide into the atmosphere is widely recognized as a significant contributor to climate change. Carbon capture and storage (CCS) techniques provide effective methods for reducing carbon dioxide emissions into the atmosphere.

Some approaches aim to extract carbon dioxide from ambient air using suitable methods. Such systems are sometimes referred to as “artificial trees.” Known methods for capturing carbon dioxide include absorption, adsorption, membrane-based systems, electrochemical separation, and cryogenic separation.

One approach involves the use of a solid sorbent as a packing material. The solid sorbent may be selected from materials such as silica gel, aluminosilicates, metal-organic frameworks (MOF), and, in particular, zeolite. The solid sorbent is a compound capable of binding a substance, such as a gas (e.g., carbon dioxide), through physical forces. Under controlled conditions, the solid sorbent can desorb the adsorbed substance. Desorption may occur through the application of heat, pressure, or the adsorption of other substances, which displaces the initially adsorbed substance.

Heat exchangers are employed to regulate the temperature of the solid sorbent. Typically, the heat exchanger is positioned within a container filled with the solid sorbent serving as the packing material. However, conventional heat exchangers used in direct air capture (DAC) systems often require significant material for construction, involve long line distances, and exhibit high pressure losses over the length of the lines. Additionally, the structural designs of known heat exchangers limit the amount of sorbent that can be accommodated.

A challenge associated with using zeolite as a solid sorbent is its chalk-like texture. Mechanical movement of zeolite causes friction between grains, leading to wear and abrasion. This abrasion results in a loss of sorbent material, which may reduce the performance of the system for adsorption and desorption of carbon dioxide.

Heat exchangers are commonly constructed from aluminum due to its favorable thermal conductivity. However, aluminum has a high coefficient of thermal expansion, causing the geometric dimensions of the heat exchanger to change during regular heating and cooling cycles. This thermal expansion induces mechanical movement of the zeolite, exacerbating wear. The arrangement of components in conventional heat exchanger designs further contributes to this issue.

WO 2018/083109A1 describes a heat exchanger for a gas separation unit used in a cyclic adsorption/desorption process to separate a first gas from a mixture. The heat exchanger includes multiple tubes and metal sheets. The tubes are arranged in a meandering configuration, and the metal sheets are positioned parallel to and spaced apart from one another, with holes through which the tubes are guided. The tubes extend perpendicular to the elongated metal sheets through these holes.

WO 2024/006521A2 describes a heat exchanger for a DAC system. The heat exchanger comprises a combination of tubes and plates arranged within a container. The container is configured to hold free-flowing bulk material serving as the sorbent. The tubes and plates are arranged parallel to one another.

### SUMMARY

Some aspects of the present disclosure provide a temperature control system, a sorbent container system, and a device configured to regulate the temperature of a sorbent packing for extracting carbon dioxide from a gaseous medium, addressing at least some of the challenges described in the background.

These aspects are achieved by the temperature control system, the sorbent container system, the device, and the use of the temperature control system as recited in the claims.

Additional embodiments of the present disclosure are described in the dependent claims and the following description of exemplary embodiments.

Some embodiments of the present disclosure relate to a temperature control system configured to regulate the temperature of a sorbent packing for extracting carbon dioxide from a gaseous medium. The temperature control system includes: a tube system comprising at least one tube; and a lamella system disposed within the sorbent packing, including at least one elongated lamella, wherein the tube extends along a longitudinal direction of the lamella and contacts the lamella along the longitudinal direction.

In some embodiments, the temperature control system functions as a heat exchanger configured to heat and cool the sorbent packing. Heat transfer from the temperature control system to the sorbent packing may occur via convection, conduction, or both. A temperature control medium flows through the tube system to regulate the temperature. The temperature control medium may be vaporous or liquid.

The temperature control medium may be introduced at a pressure ranging from 5 bar to 11 bar, such as from 6 bar to 10 bar, from 7 bar to 10 bar, or at approximately 8 bar.

The sorbent packing may comprise a physisorbent and may be in granular form, such as spherical granules. In some embodiments, the sorbent packing includes zeolite or may be selected from materials such as silica gel, aluminosilicates, or metal-organic frameworks (MOF). The gaseous medium may be ambient air.

The lamella system is positioned within the sorbent packing, such that the lamella system is at least partially surrounded by the sorbent packing. In some embodiments, the lamella is configured to be inserted into the sorbent packing in a sword-like manner, with the sorbent packing in contact with the lamella system.

The elongated lamella may have a sword-like design, with a first length along the longitudinal direction greater than a second length in a direction perpendicular to the longitudinal direction.

The tube and the elongated lamella are oriented parallel to each other along the longitudinal direction. The tube physically contacts the lamella in a region along the longitudinal direction, transferring heat to the lamella over an extended contact surface. This configuration concentrates thermal expansion of the temperature control system primarily in the longitudinal direction, minimizing mechanical movement of the sorbent packing. The minimal thickness of the lamella ensures that thermal expansion in the thickness direction has negligible impact on the sorbent packing.

The lamella transfers heat to the sorbent packing primarily through its two lateral surfaces, maximizing the heat transfer surface area.

In some embodiments, the tube system and the lamella system are made of aluminum due to its favorable thermal conductivity. Other materials with comparable thermal conductivity may also be used.

The temperature control system of the present disclosure is configured to minimize the flow resistance of air passing through the system. The design optimizes heat transfer between the tube system and the lamella system, increases the amount of sorbent packing that can be accommodated, and reduces thermal expansion-induced mechanical movement of the sorbent packing, thereby decreasing wear. Additionally, the system facilitates easy addition and removal of the sorbent packing.

### BRIEF DESCRIPTION OF THE DRAWINGS

Exemplary embodiments of the present disclosure are described below with reference to the accompanying drawings, in which:

FIG. 1 shows a schematic side view of a temperature control system, according to some aspects of the present disclosure;

FIG. 2 shows a perspective view of the temperature control system, according to some aspects of the present disclosure;

FIG. 3 shows a detailed view of a lamella including an embossing, according to some aspects of the present disclosure;

FIG. 4 shows a detailed view of a lamella including two sub-lamellae, according to some aspects of the present disclosure;

FIG. 5 shows a first embodiment of a rail system, according to some aspects of the present disclosure;

FIG. 6 shows a detailed view of the first embodiment of the rail system including a connecting element system, according to some aspects of the present disclosure;

FIG. 7 shows a second embodiment of the rail system, according to some aspects of the present disclosure;

FIG. 8 shows a third embodiment of the rail system, according to some aspects of the present disclosure;

FIG. 9 shows a schematic top view of the temperature control system including a positioning system, according to some aspects of the present disclosure;

FIG. 10 shows a schematic representation of a positioning element, according to some aspects of the present disclosure;

FIG. 11 shows a detailed view of the temperature control system including a diverting section, according to some aspects of the present disclosure;

FIG. 12 shows a second embodiment of the lamella, according to some aspects of the present disclosure;

FIG. 13 shows a perspective detailed view of the temperature control system including the second embodiment of the lamella, according to some aspects of the present disclosure;

FIG. 14 shows a sectional view of the temperature control system including the second embodiment of the lamella, according to some aspects of the present disclosure;

FIG. 15 shows a schematic side view of a sorbent container system, according to some aspects of the present disclosure; and

FIG. 16 shows a schematic representation of a device, according to some aspects of the present disclosure.

### DETAILED DESCRIPTION

The following description, with reference to the accompanying drawings, provides an overview followed by a detailed explanation of exemplary embodiments of the present disclosure.

In some embodiments, a flow direction of a temperature control medium within the tube extends along the longitudinal direction of the lamella.

The lamella is oriented perpendicular to the flow direction of the gaseous medium through the sorbent packing. In the region of the lamella, the flow direction of the temperature control medium may extend along the longitudinal direction of the lamella.

In some embodiments, the tube is configured to provide a rectilinear flow direction of the temperature control medium along the longitudinal direction of the lamella. Alternatively, the tube may be configured to provide an oppositely oriented flow direction. For example, the tube may have a U-shaped or meandering configuration.

The lamella and tube are arranged to minimize mechanical movement of the sorbent packing during thermal expansion in the temperature control process. This is achieved, in part, by minimizing expansion in the thickness direction of the lamella. Additionally, the tube may expand in the longitudinal direction relative to or independently of the lamella, reducing wear on the sorbent packing.

In some embodiments, the lamella includes an embossing formed along its longitudinal direction.

The embossing may comprise a deformation, defining an embossing region along the longitudinal direction of the lamella. The wall thickness of the lamella remains substantially uniform inside and outside the embossing region. The embossing may have a semi-circular shape.

The lamella, including the embossing, may be manufactured using a sheet metal forming process, a profiling process, or an extrusion process.

The embossing optimizes heat transfer by increasing the surface area for heat transfer. The uniform wall thickness of the lamella ensures consistent temperature control of the sorbent packing.

In some embodiments, the tube is positioned within the embossing and is at least partially surrounded by the embossing.

The tube may be partially or fully enveloped by the embossing. The semi-circular embossing may be shaped to conform to the diameter of the tube.

The tube extends within the embossing and contacts the lamella along the longitudinal direction within the embossing.

The tube may be attached to the lamella by clipping or flanging, allowing the tube to extend within the embossing free of thermal stress and to thermally expand independently of the lamella, thereby avoiding material-related thermal shear stress. Alternatively, the tube may be attached to the lamella by brazing or welding.

The tube and embossing are configured to optimize heat transfer from the tube to the lamella and from the lamella to the sorbent packing, improving the efficiency of the temperature control system.

In some embodiments, the lamella comprises two sub-lamellae, each with a sub-embossing, wherein the sub-embossings form a channel structure within the lamella.

The two sub-lamellae may have an axially symmetrical or mirror-symmetrical design and, in an installed position, are arranged symmetrically relative to each other. The sub-lamellae contact each other outside the embossing region, preferably across their entire surface outside the embossing region, to maximize heat transfer.

The channel structure may have a substantially circular cross-section or an alternative cross-sectional shape. The channel structure, formed by the two sub-embossings, may extend completely through the lamella along the longitudinal direction and may include one or more individual channels.

In some embodiments, the channel structure includes one or more diverting sections. When multiple diverting sections are present, the channel structure may have a meandering shape.

In some embodiments, the tube is positioned within the channel structure.

The tube may be fully enveloped by the channel structure in the region of the lamella and extends within the channel structure, contacting the lamella along the longitudinal direction. The tube extends within the channel structure free of thermal stress.

The tube may extend along the entire length of the channel structure. Alternatively, the tube may extend only partially along the channel structure, such as in an end region of the channel structure.

In embodiments where the tube extends only partially along the channel structure, the channel structure is configured to be media-impermeable, allowing the temperature control medium to flow through it. The two sub-lamellae may be joined by brazing to form a media-impermeable and pressure-tight channel structure.

In some embodiments, the two sub-lamellae are joined in a form-locked manner, such as by a clinch connection or a rivet connection. A clinch connection is particularly advantageous, as it joins the sub-lamellae around the tube while avoiding thermal stresses between the tube and the lamella.

Alternatively, the sub-lamellae may be integrally joined, such as by brazing or welding.

In some embodiments, the tube includes a first connecting section and a second connecting section, both located on a first end face of the lamella.

The first and second connecting sections may be arranged on the same side of the lamella and form a one-piece tube. The first and second connecting sections may be positioned one above the other relative to the lamella.

The first connecting section may serve as an inlet for the temperature control medium, such as for introducing hot vapor. The second connecting section may serve as an outlet for the temperature control medium, such as for draining condensate.

The first connecting section may protrude beyond the first end face of the lamella and may divert the tube upward, for example, by 90° relative to the longitudinal direction of the lamella. Similarly, the second connecting section may protrude beyond the first end face and divert the tube downward, for example, by 90° relative to the longitudinal direction.

This configuration facilitates a compact connection within a superordinate assembly.

In some embodiments, the tube includes a diverting section located on a second end face of the lamella.

The tube, including the diverting section, forms a one-piece structure. The diverting section may protrude beyond the channel structure on the second end face. A cut-out may be provided in the lamella to accommodate the diverting section, allowing the diverting section to end flush with the end face of the lamella, enabling independent thermal expansion of the tube relative to the lamella.

The tube is bent in the diverting section, which may divert the flow direction within the tube by 180°, such as in a U-shaped configuration. This enables a bidirectional or counter-flow direction within the tube along the longitudinal direction of the lamella.

In some embodiments, vapor serving as the temperature control medium flows through the temperature control system from top to bottom, with condensate draining downward. Alternatively, a liquid temperature control medium flows from bottom to top, with venting occurring upward.

In some embodiments, the temperature control system includes a rail system comprising a first rail connected to the first connecting section and a second rail connected to the second connecting section.

The rail system may function as a connecting system. The first and second rails may have an elongated, hollow design with an angular or circular cross-section. The tube is integrated into the rail system via the connecting sections.

The tube may be connected to the rail system in a media-impermeable manner.

The first and second rails may include one or more cut-outs, such as boreholes, through which the tube is connected to the rails. The connection may be an integral connection, such as a welded joint, brazed joint, or laser-welded joint, including a remote laser welding process.

Each rail may be configured as a U-shaped profile with a cover mounted in a media-impermeable and pressure-tight manner. The cover may be integrally joined to the U-shaped profile, such as by welding, laser welding (e.g., tactile laser welding), or brazing. Alternatively, the cover may be detachably connected to the U-shaped profile via a force-fit connection, such as a screw connection, to enhance mounting and accessibility. The first rail can be an upper rail. The second rail can be a lower rail. In an installed position, the first rail can be arranged above the second rail.

In the first connecting section, the tube may be connected flush to a rail bottom of the first rail. This allows condensate that develops to be discharged through the tube. This avoids the formation of condensation puddles.

The second rail may be configured such that the condensate may be discharged centrally.

The rail system may be made of aluminum.

The rail system may be connected to a connecting element system. The temperature control medium may be supplied and discharged via the connecting element system. The connecting element system may comprise multiple connecting elements. A first connecting element may be connected to the first rail. A second connecting element may be connected to the second rail. The connecting elements may each be centrally positioned at the rail.

The connecting element may be a connector. The connecting element may be provided for connecting a vapor and/or condensate hose. The connecting element may be arranged between the rail system and the hose. The connecting element may be integrally joined to the rail system. The connecting element may be brazed into the rail system. The connecting element is preferably made of stainless steel. The stainless steel may be 1.4404 stainless steel. This allows a corrosion-free connection between the rail system and the connecting element to be implemented. As an alternative, the connecting element may be connected to the rail system by way of a media-impermeable and pressure-tight screw connection.

The rail system may be arranged so as to not be in direct contact with the lamella system. This decouples the thermal expansion of the rail system and of the lamella system in relation to one another. This avoids a mechanical movement of the sorbent packing during the temperature control process.

In some embodiments, the tube system comprises multiple tubes, and the lamella system comprises multiple lamellae, which are each arranged parallel to and spaced apart from one another.

The multiple tubes of the tube system and the multiple lamellae of the lamella system are each arranged so as to be located next to one another. One tube of the multiple tubes in each case extends in the above-described manner relative to a respective lamella of the multiple lamellae.

The multiple lamellae are arranged with respect to one another in a manner similar to a column radiator. The multiple lamellae are not in contact with one another. The multiple lamellae may in each case be spaced an equal distance apart from one another. The distance between the lamellae may range between 15 mm and 30 mm, advantageously between 20 mm and 25 mm. A different distance would also be conceivable. The selection of the distance depends on the selection of the sorbent packing. The sorbent packing is arranged between the lamellae. This ensures optimal temperature control of the sorbent packing. This ensures uniform heating of the sorbent packing.

The multiple tubes do not make contact with one another. The multiple lamellae are coupled to one another by way of the first rail and the second rail and the multiple tubes. The flow direction is always the same within the multiple tubes.

A length of the first rail and a length of the second rail may in each case extend at least over a length of the multiple parallel, spaced-apart tubes. The first rail and the second rail may each be oriented centrally with respect to the tube system and the lamella system.

The rail system positions the multiple lamellae so as to be fixed with respect to one another. The rail system positions the multiple lamellae on the first end face so as to be fixed with respect to one another.

This allows the sorbent packing to be easily added and emptied. As a result, the amount of sorbent for which the temperature control system can control the temperature may be increased.

The second rail, serving as a lower rail, may be configured such that the condensate is discharged centrally. The second rail may extend in a V-shaped manner. The second rail may comprise a rail bottom, which extends in a V-shaped manner. Due to the V shape, the condensate may be discharged or drain centrally.

In some embodiments, the temperature control system further comprises a positioning system, wherein the positioning system positions the multiple lamellae so as to be fixed with respect to one another.

The positioning system may comprise multiple positioning elements. The multiple positioning elements may position the multiple lamellae so as to be fixed with respect to one another. The positioning system may comprise three positioning elements, for example. The first positioning element may position the multiple elongated lamellae with respect to one another along the longitudinal direction in the region of a central position. The second and third positioning elements may position the multiple elongated lamellae with respect to one another along the longitudinal direction in the region of a second end face. In this way, an identical distance between the lamellae is achieved, which ensures uniform or even heating of the sorbent.

The positioning elements may have a strut-like design. A comb-like section may be formed on the positioning elements. The positioning system may be connected to the lamella system in a form-locked manner. The positioning system may position the multiple lamellae by way of form fit so as to be fixed with respect to one another. This way, a pivoting of the lamellae may be avoided.

As a result, the temperature control system may be stabilized during mounting and during operation. As a result, the distances of the multiple lamellae with respect to one another remain the same during thermal expansion. The lamellae may be preoriented by way of the positioning system. In this way, the mounting of the temperature control system may be facilitated.

Some embodiments of the present disclosure relate to a sorbent container system for a device for extracting carbon dioxide from a gaseous medium, comprising the temperature control system described herein, a container, and a sorbent packing, wherein the sorbent packing is arranged in the container, and the temperature control system is at least partly arranged within the sorbent packing in the container.

The container may be pan-like. The temperature control system lies in the pan-like container. The container is filled with the sorbent packing.

The gaseous medium (ambient air) may be introduced through openings in the container into an upper lateral surface of the lying temperature control system. Thereafter, the gaseous medium may be conducted through the sorbent packing for the adsorption of carbon dioxide. The gaseous medium may be discharged through openings in the container via a lower lateral surface of the temperature control system. The sorbent packing is heated by way of the temperature control system for desorbing the carbon dioxide.

As an alternative, the sorbent container system may comprise multiple containers and multiple temperature control systems. The multiple containers may be arranged next to one another and/or on top of one another. The multiple containers may be arranged in a shelf-like manner with respect to one another. The multiple containers may be coupled to one another corresponding to an advantageous flow path of the gaseous medium.

Some embodiments of the present disclosure relate to a device for extracting carbon dioxide from a gaseous medium comprising the sorbent container system described herein and/or the temperature control system described herein.

The device comprises the sorbent container system described herein. The device comprises the temperature control system described herein. The device comprises the sorbent container system described herein and the temperature control system described herein. The device may further comprise a preconditioning unit. The device may comprise further modules that are necessary for extracting carbon dioxide from the gaseous medium.

The device may be a direct air capture (DAC) plant.

Some embodiments of the present disclosure relate to a use of the temperature control system, for controlling the temperature of a sorbent packing, for extracting carbon dioxide from a gaseous medium.

The temperature control system is used to extract carbon dioxide from the gaseous medium. The temperature control system is used to extract carbon dioxide from the ambient air. A use for other applications is also conceivable.

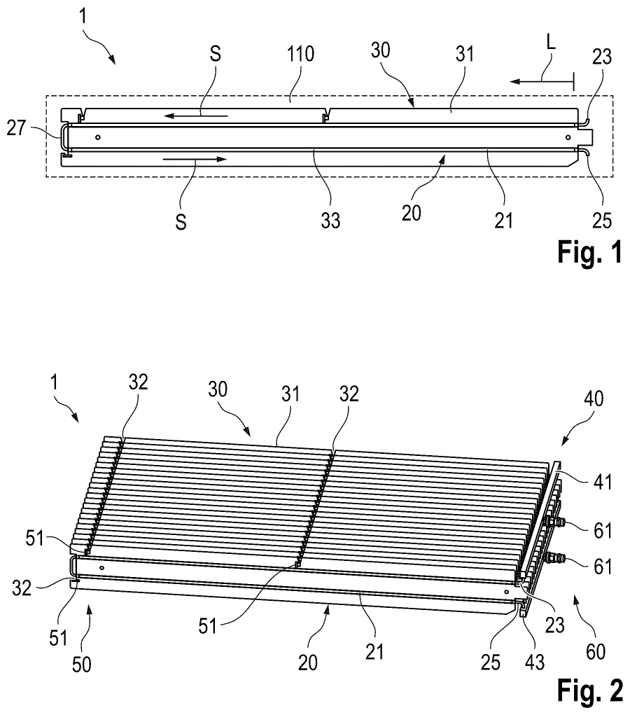

Coming back to the accompanying drawings, FIG. 1 schematically shows an exemplary embodiment of a temperature control system 1 described herein for controlling the temperature of a sorbent packing 110. The sorbent packing 110 is schematically shown as a dotted frame. The temperature control system 1 is surrounded by the sorbent packing 110. The temperature control system comprises a tube system 20 including a one-piece tube 21 and a lamella system 30 including an elongated lamella 31. The U-shaped tube 21 extends along a longitudinal direction L of the lamella 31. The tube 21 contacts the lamella 31 along the longitudinal direction L. The tube 21 extends in two passes that are parallel to and spaced-apart on top of one another along the longitudinal direction L of the lamella 31.

The U-shaped tube 21 comprises a first connecting section 23 and a second connecting section 25 on a first end face (right side) of the lamella 31. The two connecting sections 23, 25 protrude beyond the first end face of the lamella 31. The two connecting sections 23, 25 are bent and divert both the tube 21 and a flow direction S by 90°.

The tube 21 further comprises a U-shaped diverting section 27. The diverting section 27 is arranged on a second end face (left side). The diverting section 27 diverts the flow direction S by 180°.

FIG. 1 shows the flow direction S by way of example for the case where a temperature control medium is introduced via the first connecting section 23. The temperature control medium runs in an upper section of the tube 21 along the longitudinal direction L of the lamella from a right side to a left side. The diverting section 27 diverts the temperature control medium by 180°. Thereafter, the temperature control medium runs in a lower section of the tube 21 from the left side to the right side, toward the second connecting section 25.

FIG. 2 shows a perspective view of the temperature control system 1 described herein. The tube system 20 comprises multiple tubes 21, and the lamella system 30 comprises multiple lamellae 31. The multiple tubes 21 and the multiple lamellae 31 are each arranged parallel to and spaced apart from one another. A tube 21 and a lamella 31 are in each case arranged in accordance with the illustration and description with respect to FIG. 1.

The multiple lamellae 31 of the lamella system 30 are positioned so as to be fixed with respect to one another by way of a positioning system 50. The positioning system 50 comprises multiple positioning elements 51. A positioning element 51 is arranged centrally along the longitudinal direction L of the lamella 31. Two further positioning elements 51 are arranged in the region of the second end face. The positioning elements 51 are each arranged in a fixation cut-out 32 on the lamella 31.

A rail system 40 is arranged on the first end face. The rail system 40 comprises a first rail 41 and a second rail 43. The two rails 41, 43 extend over a length of the tubes 21 and lamellae 31 that are arranged parallel to one another. The two rails 41, 43 are arranged parallel to and on top of one another. The first rail 41 is connected to the upper first connecting section 23. The second rail 43 is connected to the lower second connecting section 25.

The rail system 40 is connected to a connecting element system 60. A connecting element 61 of the connecting element system 60 is connected to the first rail 41. A further connecting element 61 is connected to the second rail 43.

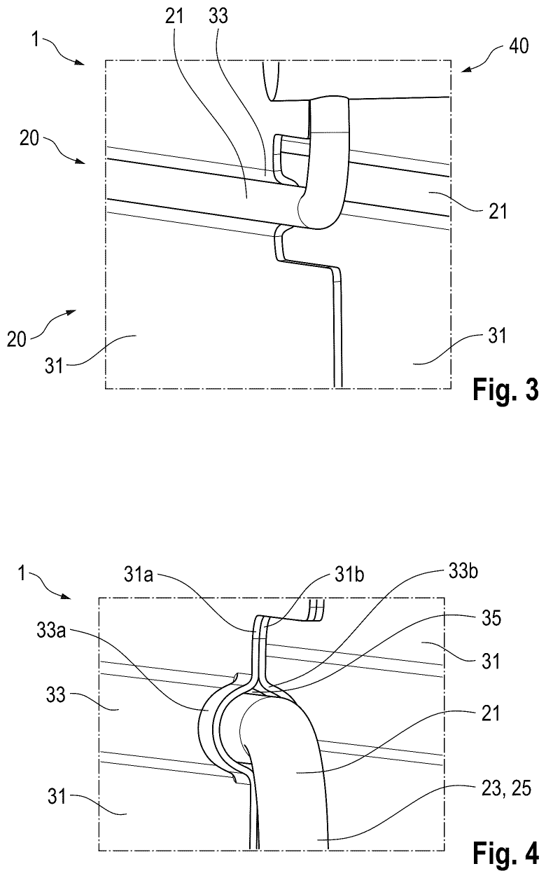

FIG. 3 shows a detailed view of a lamella 31 including an embossing 33. The detailed view shows the region of the first end face of the lamella 31 by way of example. The embossing 33 has a semi-circular design. The tube 21 is surrounded or enveloped halfway by the embossing 33. The embossing 33 follows a circumference of the tube 21. The tube 21 contacts the lamella 31 along the longitudinal direction L in the region of the embossing 33.

FIG. 4 shows a detailed view of the lamella 31 including two sub-lamellae 31a and 31b. The two sub-lamellae 31a and 31b have an axially symmetrical or mirror-symmetrical design and arrangement. Each of the two sub-lamellae 31a, 31b has a sub-embossing 33a, 33b. Each of the two sub-embossings 33a, 33b has a semi-circular design. The two sub-embossings 33a, 33b form a shared round channel structure 35 within the lamella 31. The channel structure 35 extends along the longitudinal direction L through the lamella 31. The tube 21 is arranged in the channel structure 35. The channel structure 35 completely surrounds or envelops the tube 21. The tube 21 contacts the lamella 31 along the longitudinal direction L within the channel structure 35.

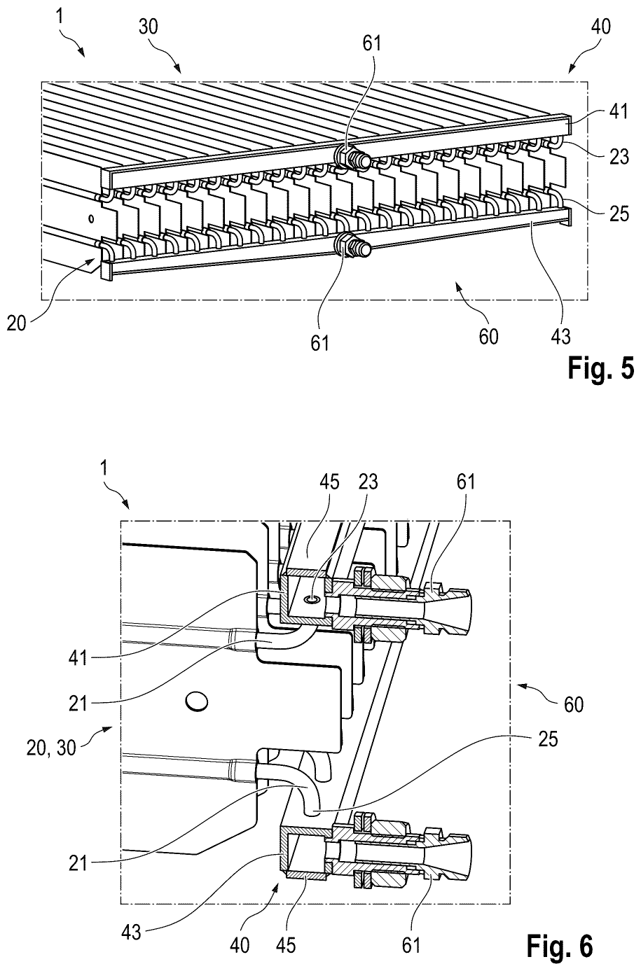

FIG. 5 shows a first specific embodiment of the rail system 40 on the temperature control system 1. The detailed view of FIG. 5 essentially corresponds to the first end face of the temperature control system 1 shown in FIG. 2.

Each of the two rails 41, 43 has a quadrangular cross-section including a cavity. The two rails 41, 43 of the rail system 40 are arranged centrally with respect to the multiple tubes 21 of the tube system 20. The multiple first connecting sections 23 of the multiple tubes 21 are each connected to a rail bottom of the first rail 41. The multiple second connecting sections 25 of the multiple tubes 21 are each connected to an upper side of the second rail 43.

A connecting element 61 of the connecting element system 60 is in each case centrally positioned at the first rail 41 and at the second rail 43.

The lower second rail 43 has a rail bottom that extends in a V shape toward the center.

A rail system 40 is arranged on the first end face. The rail system 40 comprises a first rail 41 and a second rail 43. The two rails 41, 43 extend over a length of the tubes 21 and lamellae 31 that are arranged parallel to one another. The two rails 41, 43 are arranged parallel to and on top of one another. The first rail 41 is connected to the upper first connecting section 23. The second rail 43 is connected to the lower second connecting section 25.

The rail system 40 is connected to a connecting element system 60. A connecting element 61 of the connecting element system 60 is connected to the first rail 41. A further connecting element 61 is connected to the second rail 43.

FIG. 6 shows a detailed view of the rail system 40 shown in FIG. 5 including the connecting element system 60. The connecting element system 60 is provided by way of example.

The rail system 40 corresponds to the first specific embodiment of the rail system 40. The first and second rails 41, 43 in each case have a U-shaped profile and a cover 45. The U-shaped profile is closed by way of the cover 45 for forming the cavity.

The tube 21 is connected flush to the rail bottom of the first rail 41. An opening of each tube 21 is connected to the cavity of the first rail 41 and of the second rail 43. The two connecting elements 61 of the connecting element system 60 are connected to a leg side of the rail 41, 43. An opening of the connecting elements 61 is connected to the cavity of the rail 41, 43.

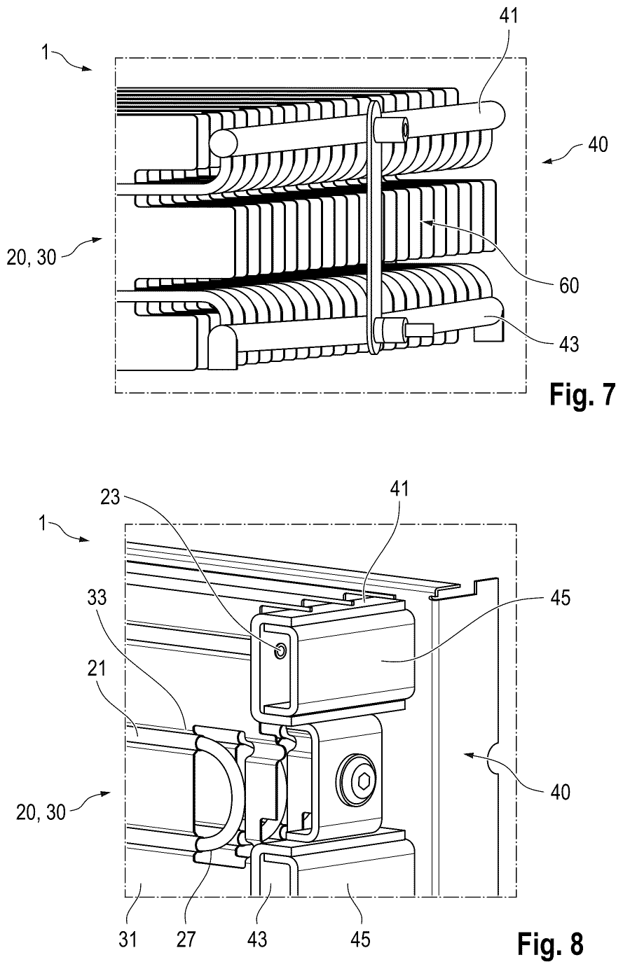

FIG. 7 shows a second specific embodiment of the rail system 40. In contrast to the first specific embodiment, the rail system 40 of the second specific embodiment has a first and a second rail 41, 43, each having a round cross-section. The first and second rails 41, 43 each have a tubular design. The lower second rail 43 extends in a V-shaped manner. The basic arrangement of a connection of the tube system 20 occurs essentially identically to the first specific embodiment.

FIG. 8 shows a third specific embodiment of the rail system 40. In contrast to the first specific embodiment, the rail system 40 of the third specific embodiment has a first and a second rail 41, 43, each having a rectangular cross-section. The rectangular cross-section is formed by two U-shaped profiles, which are pushed inside one another with the legs thereof.

The tube 21 is connected to the lamella 31 by way of a clip connection. The tube 21 further comprises multiple diverting sections 27. The tube 21 extends in four passes that are parallel to and on top of one another along the longitudinal direction L of the lamella 31.

The three specific embodiments of the rail system 40 are not limited to the use of a particular design of the lamella system 30 and tube system 20. The three specific embodiments of the rail system 40 may be arbitrarily combined.

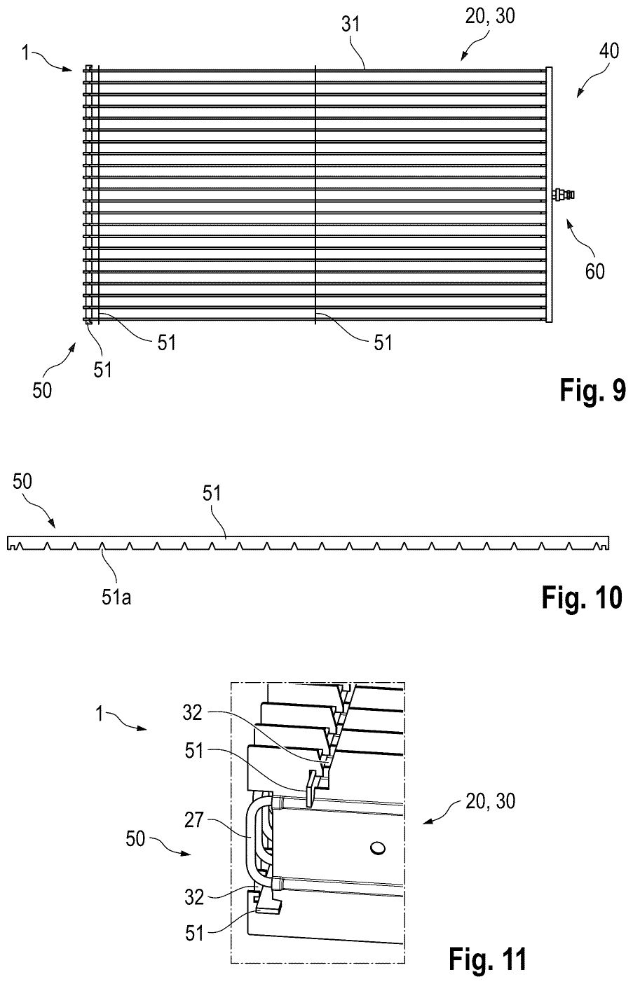

FIG. 9 shows a schematic top view onto the temperature control system 1 described herein including the positioning system 50. The temperature control system 1 of FIG. 9 essentially corresponds to the temperature control system 1 shown in FIG. 2.

The multiple lamellae 31 that are parallel to and spaced apart from one another do not make contact with one another. The lamellae 31 of the lamella system 30 are in each case spaced the same distance apart from one another. The distance between the lamellae 31 is maintained by way of the positioning system 50. The individual positioning elements 51 extend vertically to the longitudinal direction L of the lamellae 31. A length of the individual positioning elements 51 corresponds at least to a length of the multiple lamellae 31 that are arranged next to one another.

A volume is formed by way of the distance between the lamellae 31. A volume between the lamellae 31 is provided for the sorbent packing 110 (not shown). The volume between the lamellae 31 is designed to receive the sorbent packing 110.

FIG. 10 shows a schematic representation of an exemplary positioning element 51 of the positioning system 50. The comb-like positioning element 51 has multiple fixation geometries 51a on the lower side thereof. A distance between the triangular fixation geometries 51a essentially corresponds to the distance between the multiple lamellae 31.

FIG. 11 shows a detailed view of the temperature control system 1 described herein including the U-shaped diverting section 27. The detailed view of FIG. 11 essentially corresponds to the second end face of the temperature control system 1 shown in FIG. 2. The diverting section 27 protrudes from the upper and the lower channel structure 35. The diverting section 27 is arranged in a cut-out of the lamella 31. As a result of the diverting section 27 being arranged in the cut-out, the diverting section 27 ends substantially flush with the end face of the lamella 31.

A positioning element 51 is horizontally arranged beneath the diverting section 27 in a fixation cut-out 32 in the lamella system 30. A further positioning element 51 is vertically arranged in the region of an upper end section in a fixation cut-out 32 in the lamella system 30. The positioning element 51 fixes the multiple lamellae with respect to one another by way of the triangular fixation geometry 51a. Each fixation geometry 51a engages in a respective lamella 31 for fixation.

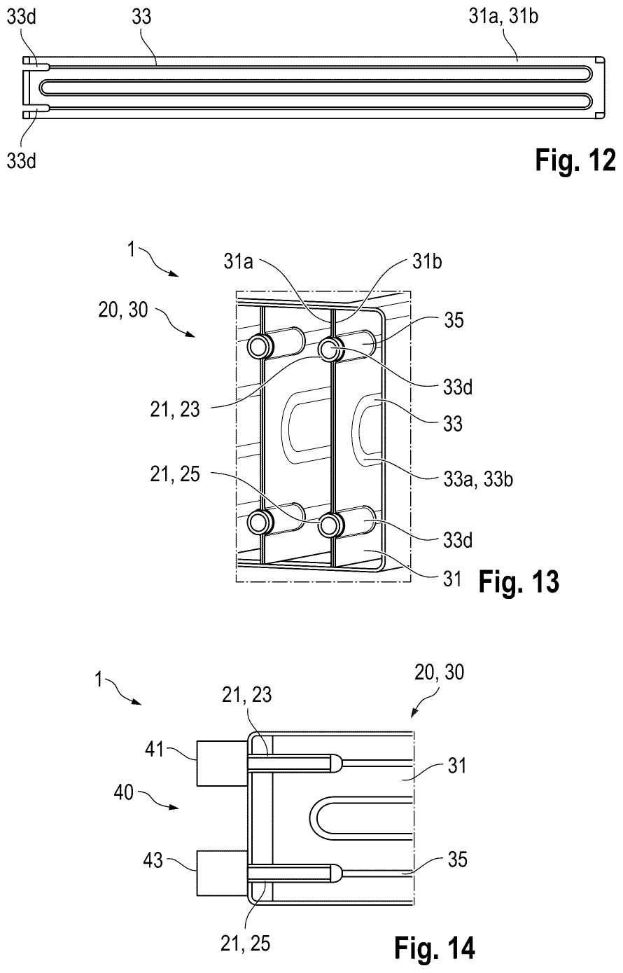

FIG. 12 shows a second specific embodiment of the lamella 31. FIG. 12 shows a sub-lamella 31a, 31b by way of example. In the second specific embodiment of the lamella 31, the channel structure 35 is likewise formed by the sub-embossings 33a, 33b. In the second specific embodiment, the channel structure 35 is designed in such a way that the temperature control medium may be conducted directly through the channel structure 35. Two connecting embossings 33d are formed on an end face (left side). The two connecting embossings 33d are connected to the sub-embossing 33a, 33b.

The embossing 33 has a meandering shape in FIG. 12. The embossing 33 has three diverting sections.

FIG. 13 shows a perspective detailed view of the temperature control system 1 described herein including the second specific embodiment of the lamella 31. The lamella 31 comprises two sub-lamellae 31a, 31b. The opposing sub-embossings 31a, 31b form the media-impermeable channel structure 35. The opposing connecting embossings 35 form a connection. The sleeve-like tube 21 is arranged subsequent to the connecting embossings 35 and forms the first connecting section 23 at the top and the second connecting section 25 at the bottom. The tube 21 extends along the longitudinal direction L of the lamella 31 and contacts the lamella 31 along the longitudinal direction L.

FIG. 14 shows a sectional view of the temperature control system 1 described herein including the second specific embodiment of the lamella 31. An end face of the tube 21 is connected to a rail system 40. An upper tube 21 is connected to the first rail 41. A lower tube 21 is connected to the second rail 43.

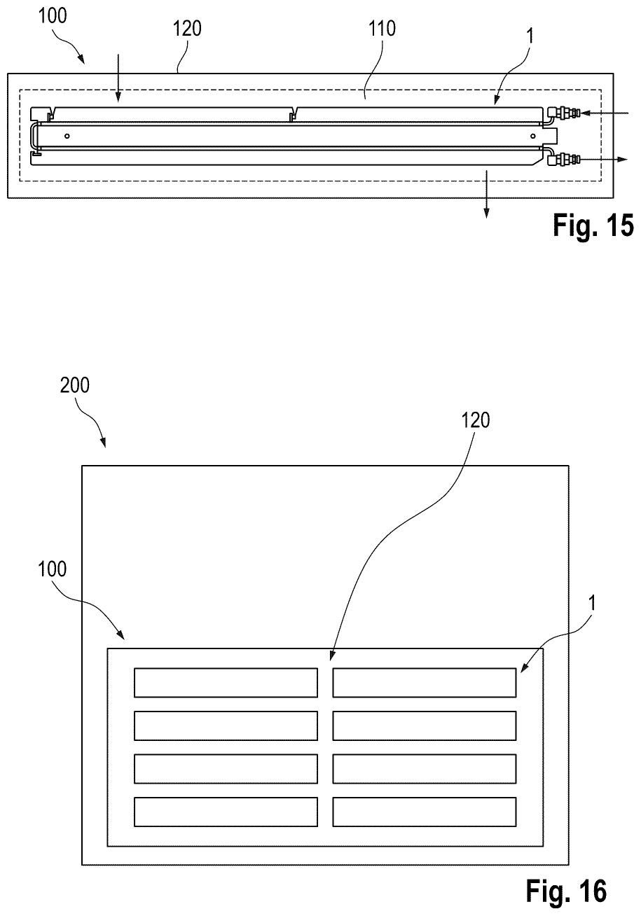

FIG. 15 shows a schematic side view of a sorbent container system 100 described herein. The sorbent container system 100 comprises a container 120, the sorbent packing 110, and the temperature control system 1. The temperature control system 1 is arranged lying in the container 120. The container 120 is filled with the sorbent packing 110 (dotted frame).

In FIG. 15, an air flow (gaseous medium) and the flow direction of the temperature control medium are plotted with arrows by way of example. An inflow of air takes place via an inlet in the container into an upper lateral surface of the lying temperature control system 1. Thereafter, the gaseous medium is conducted through the sorbent packing 110 for the adsorption of the carbon dioxide. The gaseous medium is discharged via an outlet in the container 120 on the lower lateral surface of the temperature control system 1. The sorbent packing 110 is heated by way of the temperature control system 1 for desorbing the carbon dioxide. The temperature control medium is introduced via the first rail 41 and discharged via the second rail 43.

FIG. 16 shows a schematic representation of a device 200 described herein. The device 200 comprises the sorbent container system 100 and the temperature control system 1. The sorbent container system 100 in FIG. 16 comprises multiple containers 120, each including a temperature control system 1. The multiple containers 120 are arranged next to and stacked on top of one another.

The temperature control system described herein is not limited to the use in a device for extracting carbon dioxide from a gaseous medium. The temperature control system described herein may be used for any applications for controlling the temperature of a packing or other material.

### LIST OF REFERENCE SIGNS

1 temperature control system
20 tube system
21 tube
23 first connecting section
25 second connecting section
27 diverting section
30 lamella system
31 elongated lamella
31a sub-lamella
31b sub-lamella
32 fixation cut-out
33 embossing
33a sub-embossing
33b sub-embossing
33d connecting embossing
35 channel structure
40 rail system
41 first rail
43 second rail
45 cover
50 positioning system
51 positioning element
51a fixation geometry
60 connecting element system
61 connecting element
100 sorbent container system
110 sorbent packing
120 container
200 device
L longitudinal direction
S flow direction

1. A temperature control system for regulating a temperature of a sorbent packing configured to extract carbon dioxide from a gaseous medium, the temperature control system comprising:
a tube system comprising at least one tube; and
a lamella system disposed within the sorbent packing, the lamella system comprising at least one elongated lamella,
wherein the at least one tube directly contacts the at least one elongated lamella along a longitudinal direction of the at least one elongated lamella.

2. The temperature control system of claim 1, wherein a flow direction of a temperature control medium within the at least one tube extends along the longitudinal direction of the at least one elongated lamella.

3. The temperature control system of claim 1, wherein the at least one elongated lamella includes an embossing configured to receive at least a portion of the at least one tube, the embossing extending along the longitudinal direction of the at least one elongated lamella.

4. The temperature control system of claim 3, wherein the at least one tube is at least partially surrounded by the embossing.

5. The temperature control system of claim 1, wherein the at least one elongated lamella comprises a first sub-lamella and a second sub-lamella, the first sub-lamella having a first sub-embossing and the second sub-lamella having a second sub-embossing, the first sub-embossing and the second sub-embossing forming a channel structure within the at least one elongated lamella.

6. The temperature control system of claim 5, wherein the at least one tube is arranged within the channel structure.

7. The temperature control system of claim 5, wherein the first sub-lamella and the second sub-lamella are mechanically interlocked to one another.

8. The temperature control system of claim 1, wherein the at least one tube includes a first connecting section and a second connecting section, the first connecting section and the second connecting section both arranged on a first end face of the at least one elongated lamella.

9. The temperature control system of claim 1, wherein the at least one tube includes a diverting section arranged on a second end face of the at least one elongated lamella.

10. The temperature control system of claim 8, further comprising a rail system comprising a first rail and a second rail, the first rail connected to the first connecting section and the second rail connected to the second connecting section.

11. The temperature control system of claim 1, wherein the tube system comprises a plurality of tubes and the lamella system comprises a plurality of elongated lamellae, each elongated lamella of the plurality of elongated lamellae arranged parallel to and spaced apart from one another.

12. The temperature control system of claim 11, further comprising a positioning system configured to position the plurality of elongated lamellae fixed with respect to one another.

13. A sorbent container system for extracting carbon dioxide from a gaseous medium, the sorbent container system comprising:
a container;
a sorbent packing arranged within the container; and
a temperature control system at least partially arranged within the sorbent packing in the container to regulate the temperature of the sorbent packing, the temperature control system comprising:
a tube system comprising at least one tube; and
a lamella system comprising at least one elongated lamella,
wherein the at least one tube directly contacts the at least one elongated lamella along a longitudinal direction of the at least one elongated lamella.

14. The sorbent container system of claim 13, wherein the container comprises a pan-like configuration.

15. The sorbent container system of claim 13, further comprising a plurality of containers arranged adjacent to one another, stacked atop one another, or both.

16. The sorbent container system of claim 13, wherein the container includes an inlet at an upper lateral surface and an outlet at a lower lateral surface, the inlet and the outlet configured to conduct the gaseous medium through the sorbent packing from the inlet to the outlet for adsorption of carbon dioxide.

17. A device for extracting carbon dioxide from a gaseous medium, the device comprising:
a sorbent container system comprising:
a container;
a sorbent packing arranged within the container; and
a temperature control system at least partially arranged within the sorbent packing to regulate the temperature of the sorbent packing, the temperature control system comprising:
a tube system comprising at least one tube; and
a lamella system comprising at least one elongated lamella,
wherein the at least one tube directly contacts the at least one elongated lamella along a longitudinal direction of the at least one elongated lamella.

18. The device of claim 17, wherein the device is configured as a direct air capture plant.

19. The device of claim 17, further comprising a preconditioning unit configured to precondition the gaseous medium.

20. The device of claim 17, wherein the sorbent container system includes a plurality of containers arranged adjacent to one another, stacked atop one another, or both.
